(19) United States
(12) Patent Application Publication
(10) Pub. No.: US 2004/0148509 A1
(43) Pub. Date: Jul. 29, 2004

(54) Method of using biometric information for secret generation

(76) Inventor: Yong Dong Wu, Singapore (SG)

Correspondence Address: OSTROLENK FABER GERB & SOFFEN, 1180 AVENUE OF THE AMERICAS, NEW YORK, NY, 100368403

(21) Appl. No.: 10/472,696

(22) PCT Filed: Mar. 23, 2001
(86) PCT No.: PCT/SG01/00051

(51) Int. Cl. H04K 1/00

(52) U.S. Cl. 713/186

(57) ABSTRACT

A method and system that generates a secret from individual's biometric information, such as voice, handwriting and fingeprint. It extracts a feature vector from the captured biometric data. The feature vector is then transformed into a codewood, and the codeword is used to construct the secret. A one-way hash of the secret is stored. Only if a user generates a new secret that has the same hash value as that stored will the user be confirmed. To keep pace with the gradual change of the measured biometric features, the a secret can be updated adaptively. The secret may be an encryption key.

### FIELD OF THE INVENTION

The present invention relates to a method for using biometric information for secret generation and refers particularly, though not exclusively, to pattern recognition for cryptographic key generation and management of a secret such as, for example; a cryptographic key,

Definitions

Throughout this specification “biometric” and its grammatical equivalent is to be taken as meaning some aspect of a person, which can be recorded and/or measured. It includes, for example, fingerprint, voice, image (as in photograph of a body part including face), palm print, or tasks preformed by the person such as, for example key strokes on a keyboard; handwriting, and so forth.

Throughout this specification a reference to secret is to be taken as including any other form of secret such as, for example, cryptographic key, password, passphrase, userID), code, or the like.

### BACKGROUND OF THE INVENTION

The rapid development of electronic transactions has stimulated a strong demand for cryptography and cryptographic systems. Apart from confidentiality, cryptography addresses two other important problems: authentication and digital signatures. A symmetric cryptographic system can only provide confidentiality and authentication but not a digital signature. However, public cryptography can satisfy all tee requirements.

In a public key cryptographic system, the algorithm and public key are always public but the private key is normally kept secret, and is only know to the key owner. The private key should be a random number that is hard to remember. However, passwords and passphrases that are easy to remember are often used and are therefore correspondingly weak. Also, both the private key and public key are often stored on a medium such as a smartcard or a floppy disk. This method has the inherent weakness that the key is lost to its owner when the medium is damaged, lost or stolen. Furthermore it is not convenient.

It is known that user keystroke features are highly repeatable, and are different for different users. (F. Monrose and A. Rubin, “Authentication via Keystroke dynamics”, Proceedings of ACM conference on computer and communication security, pp. 48-56,1997). Keystroke duration and latency between keystrokes have been investigated as features of interest. Other features such as, for example, the force of each keystroke can also be used if they can be measured. Keystroke products are being marked today (see http://www.biopassword.com).

There are many methods to implement biometric authentication by extracting individual biometric parameters.

U.S. Pat. No. 5,623,552, for “Self-authenticating identification card with fingerprint identification”, and U.S. Pat No. 5,761,329, for “Method and Apparatus employing audio and video data from an individual for authentication purposes”, both provide a method for determining the authenticity of an individual. If the individual speaks a selected phrase and the audio feature matches with that stored, the individual is authenticated. U.S. Pat. No. 4,761,807, entitled “Electronic audio communications system with voice authentication features”, requires the user to speak their password, and matches the audio data with the stored pattern, U.S. Pat. No. 5,712,912, for “Method and Apparatus for Security Handling a Personal Identification Number or Cryptographic Key Using Biometric Techniques”, and EP 752,143B1, for “Biometric, Personal, Authentication System”, both combine non-specific features with specific features to identify a human to avoid an unauthorised person from using specific biometric parameters of an authorised user.

The above prior art cannot generate a private key or secret key from the biometric parameters because biometric parameters are only stable to a limited degree, which mall be acceptable in a pattern recognition system or authentication system. To generate a private key, known systems require the parameters to be generally invariable.

U.S. Pat. No. 5,832,091, for “Fingerprint Controlled Public Key Cryptographic System”, uses a random number with a fingerprint, when a private key is needed. An FFT transform is applied and light modulation is used to re-generate the private key. It requires a FFT modulator, which is not generally available. U.S. Pat. No. 5,991,408 provides a method for creating a problem whose solution can be a representation of a biometric element. Whoever provides the biometric element will be authenticated. To create a cryptographic key, it requires a fixed biometrics feature.

“A Fuzzy Commitment Scheme.” (6^{th} ACM, conference on Computer and Communications Security, pp28-36, 1999), applies an error correcting code to obtain a stable code to authenticate the user. In the paper, the authors propose to transform the biometric information into a random error-correcting code, and a modifier. The hash value of the error correcting code and the modifier are publicly available. When an individual needs to authenticate themselves, the biometric parameters are extracted and used to regenerate an error-correcting code. If the hash value of the new error-correcting code is the same as that stored, the individual is authenticated. The authors have assumed that the Hamming distance between the pattern template and the sample is less than a threshold. This assumption seems to be incorrect as the Euclidean distance between the pattern template and the sample is a reasonable similarity measurement, which is generally accepted worldwide.

Further prior art references include:

F. Monrose, M. K. Reiter and Susanne Wetzel, “Password Hardening Based on Keystroke Dynamics”, 6^{th} ACM conference on Computer and Communications Security, pp.73-82, 1999;

T. R. N. RAO and E. Fujiwara, “Error Control Coding for Computer Systems”, Prentice Hall inc., 1989, ISBN 0-13-283953-9;

U.S. Pat. No. 5,991,408 Peter Kelley Pearson, Thomas Edward Rowley and Jimmy Ray Upton, “Identification and Security Using Biometric Measurements”;

U.S. Pat. No. 6,021,212 of Heng-Chun Ho, “Electronic Key Device using a fingerprint to initiate Computer System”; and

BioAPI Consortium at http://www.bioapi.org/

### SUMMARY OF THE INVENTION

The present invention therefore provides a method for generating a secret from biometric data obtained of and from a user, the method including the steps of extracting a feature vector from the biometric data; extracting from the biometric data a mean vector of the biometric data and a variance vector of the biometric data; generating a codeword from the mean vector and a random vector; and generating the secret from the codeword.

Preferably, the mean vector of the biometric data and a variance vector are determined after the feature vector has been extracted and before the secret is created. The codeword may be first mapped into an integer. The codeword may be obtained from the difference between the mean vector and the random vector. The random vector may be generated such that all components of the random vector are random. The codeword may be in a codebook, the codebook being determined by the variance vector.

The mapping of the codeword may be by calculating the hash value of the codeword, and the integer may be used to generate the secret. The generation of the secret may be by generating the hash value of the integer.

A one-way hash of the secret is preferably stored in a database, more preferably with the random vector and the variance vector.

The biometric data is preferably captured a plural number of times, and the one-way hash of the secret may be compared to the one-way hash of a new secret for verification of the new secret. The new secret is generated by extracting a new feature vector from the new biometric data, recovering the random vector, generating a new codeword from the new feature vector and the random vector, and generating the new secret from the new codeword. The new codeword may first be mapped into a new integer by calculating a one-way hash of the new codeword. Following verification of the new secret the variance vector and the random vector are preferably recovered from the database, and a nest variance vector calculated using the variance vector and the new biometric data to form a recalculated variance vector, and a new random vector is generated. The recalculated variance vector and the new random vector may be stored in place of the variance vector and random vector respectively.

The secret may be an encryption key.

The present invention also provides a computer-readable medium containing program instructions for performing the above method.

### DESCRIPTION OF THE DRAWINGS

In order that the invention may be fully understood and put into practical effect there shall now be described by way of non-limitative example only a preferred embodiment of the present invention, the description being with reference to the accompanying illustrative drawings in which:

FIG. 1 is a flow chart of secret registration;

FIG. 2 is a flow chart of the secret retrieval process; and

FIG. 3 is a flow chart of the secret updating process.

### DESCRIPTION OF THE PREFERRED EMBODIMENT

In the use of biometric information to generate a secret such as, for example, key for encryption or like purposes, there are three stages: the gathering of the biometric information; the processing of the biometric information; and the generating of the secret. The present invention is concerned with the middle stage—the processing.

A cryptographic key is a form of secret having for example, b 64 or 128 bits. A secret may have any number of bits, but a secret with only a few numbers of bits is easily broken, and a secret with a relatively large number of bits can be obtained from a cryptographic key.

This invention includes three processes: registration, retrieval and update. In the first step, the registrant's biometric data is sampled a plural number of times and a biometric feature vector is extracted from one of the samples. Because the sample value of any feature is random, the mean vector and the variance vector can be obtained. It then transforms the mean vector into a codeword of a codebook, and generates a secret with the codeword. In the second step, the system recovers the secret with biometric samples. This process is similar to the registration procedure but the biometric data is sampled only once, and it has an additional confirmation procedure. This confirmation procedure is necessary to establish that the claimant is not a forger. After obtaining the biometric data a new feature vector is established from it. A new codeword is then obtained from a codebook using the new feature vector, and a new secret generated using the new codeword. The confirmation procedure then takes place. The last step is for automatic performance upgrading when the registrant gradually changes their biometric feature. This can be used to refresh the database to keep up with any such changes. Only the successful claimant can initiate this step.

The following description relates to the generation of a cryptographic key. However, it may be used to generate any form of secret.

Key Registration

After a user has entered the required biometric data and it has been acquired by a device (such as, for example, a computer) a feature extraction procedure can be applied to the data to obtain the necessary features. The features may be dependent on the original data. Some of them may be meaningful, and others may not.

The nature of the features is not important because the present invention concerns the data, its application and implementation.

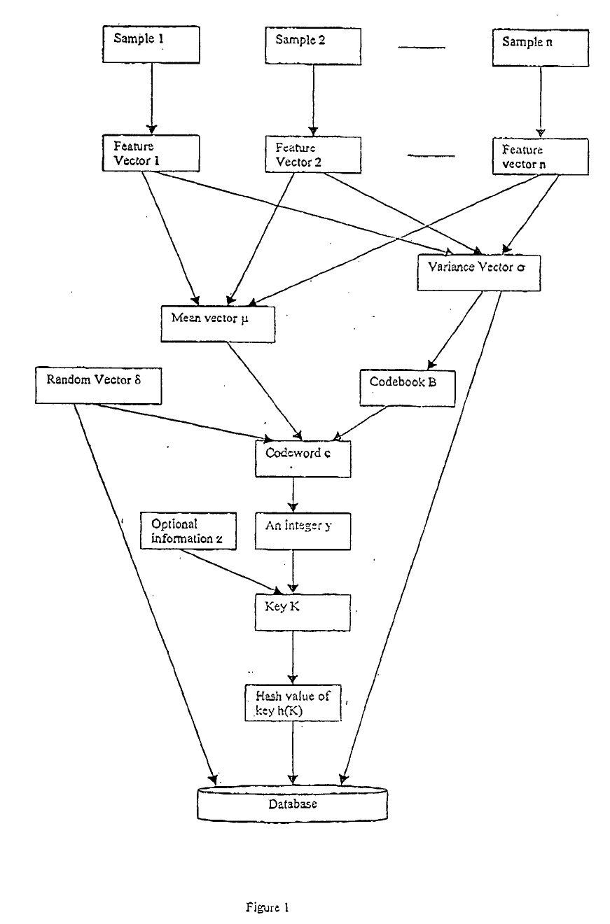

Assume there are s features, noted as X₁, X₂, . . . , Xₛ, is a random variable. Xᵢ=μᵢ+εᵢ, where μᵢ is the mean, and εᵢ is a Gaussian noise. A method to generate a key from biometric data is shown in FIG. 1:

at the first step, a device captures a registrant's biometric data a total of n times. A feature extracting process can obtain a feature vector;

at the second step, for any feature variable Xᵢ, the values are xᵢ₁, xᵢ₂, . . . , xᵢₙ. Its mean μ₁=(xᵢ₁+xᵢ₂+ . . . +xᵢₙ)/n and its variance

$${σ}_{i}^{2} = \frac{1}{n} {\sum }_{j = 1}^{n} {( {x}_{ij} - {μ}_{i} )}^{2}$$

can be calculated.

The mean vector μ is (μ₁ μ₂ . . . μₛ), and the variance vector σ is (σ₁ σ₂ . . . σₛ);

the third step can be divided into three sub-steps:

(i) assume r (0<r<1) is a system parameter and is pre-determined. A smaller r makes it harder for a forger to generate another's biometric key, while a legal individual will fail to generate their key with a higher level of probability. Based on Gaussian distribution assumption

$${\int }_{- r}^{r} \frac{1}{\sqrt{2 π}} {ⅇ}^{- {x}^{2} / 2} ⅆ x ,$$

we can estimate the error rate. On the other hand, we can select the radius r based on a predetermined error rate;

(ii) setting up a codebook B={(w₁,w₂, . . . ,wₛ)|wᵢ=kᵢrσᵢ, j=1,2, . . . , s, kᵢεZ}, where a codeword itself is a vector; and

(iii) selecting a random vector δ=(δ₁ δ₂ . . . δₛ), whose all components are random, such that codeword vector c=(c₁ c₂ . . . cₛ) is a codeword in codebook B, where cᵢ=μᵢ−δᵢ, i=1,2, . . . , s.

at the fourth step, codeword c is mapped into an integer y. This may be done, for example, by calculating the hash value of c. If there is other information z (such as keyed characters) which can be used to generate the key, h₁(y,z) is the biometric key K. Otherwise, h₂(y) can be the biometric key K; where h₁(·) and h(·) are one-way hash functions;

at the fifth step, the hash value of K is calculated with a one-way hash function h(·); and

at the final step, the codeword c and mean vector μ are discarded; and random vector δ and variance vector σ, as well as the one-way hash of the key h(K), are deposited into a database.

Key Retrieval

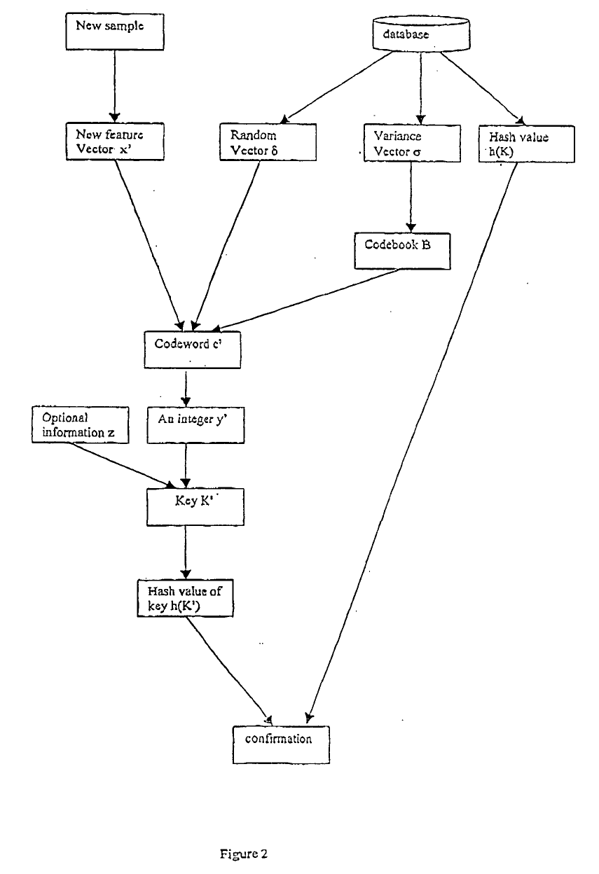

After an individual has registered their biometric key, they can make use of it. For example, they may like to encrypt a document faith their biometric key. To do that, their biometric information will again be captured with a device (e.g., camera, keyboard) and a feature vector will be extracted from this new sample. The following steps can recover their biometric key, as shown in FIG. 2:

first, the new sample is captured and the feature vector x′=(x₁′x₂′ . . . xₛ′) extracted;

secondly, the random vector δ=(δ₁ δ₂ . . . δₛ) is obtained from the database set up as shown in FIG. 1 and described above;

thirdly, a codeword

$${c}^{′} = ( {c}_{1}^{′} {c}_{2}^{′} … {c}_{5}^{′} ) = arg {min}_{c ϵ B} ‖ {x}^{′} - δ - c ‖$$

is found. There are only 2^{s} candidate codewords, which can be enumerated easily if the claimant is authentic. Thus, one can find the nearest codeword c′ efficiently by comparing the Euclidean distance between (x′−δ) and every one of these 2^{s} codewords in the codebook B;

fourthly, the codeword c′ is mapped into an integer, to form a secret key K′ with other information such as the keyed characters. This step is the same as the fifth step shown in FIG. 1 and described above;

fifthly, the hash of the key earlier obtained h(K) is retrieved from the database, which is set up in the final step shown in FIG. 1 and described above;

the penultimate step is used to verify whether or not the candidate key K′ is the biometric key. If the hash values h(K′) and h(K) are the same, K′ is the biometric key. Otherwise, the user has to try again; and

finally the biometric key K′ is output for use.

Adaptive Upgrade

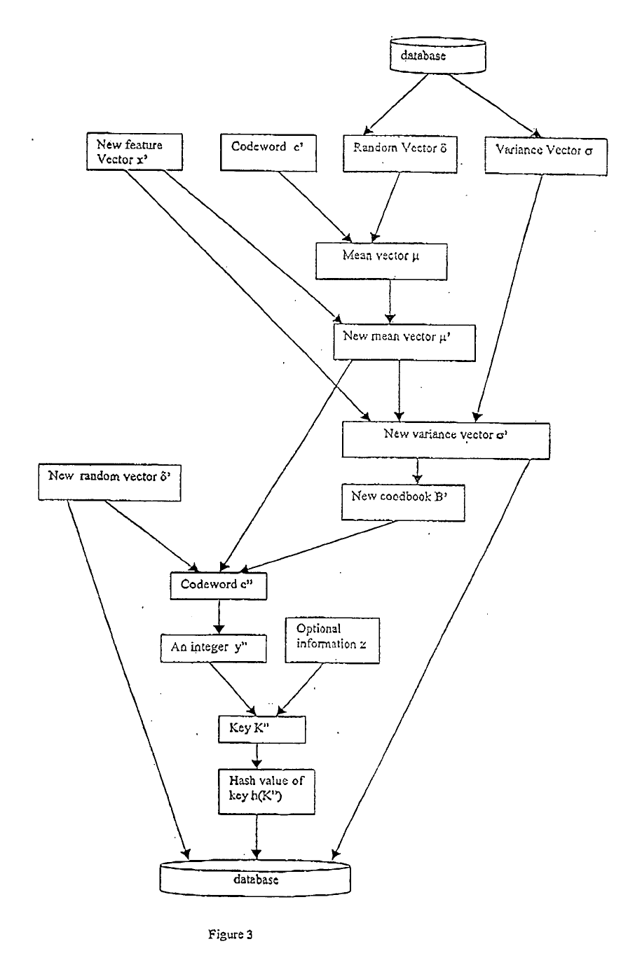

A feature extraction procedure may not always produce the same feature vector as a result of distortion of the sample data. This distortion may result from a change in the individual's habit. To be robust, the system should be able to upgrade adaptively. If the user reconstructs the biometric key successfully, the feature vector is x′, which is generated in the first step of FIG. 2. As shown in FIG. 3:

at the first step, the old mean vector μ=c′+δ is recovered. The codeword c′ is derived at the third step of FIG. 2 and the random vector δ can be obtained from the database produced in the final step of FIG. 1. The new mean vector is:

μ′=αμ+(1−α)x′ where 0.5<α<1

the old variance vector σ=(σ₁ σ₂ . . . σₛ) is then obtained from the database. The new variance vector σ′=(σ₁′σ₂′ . . . σₛ′)

σᵢ′²=βσᵢ²+(1−β)(xᵢ′−μᵢ′)² i=1,2, . . . , s where 0.5<β<1 is then calculated;

the third stage can be divided into three sub-steps:

(i) setting-up a codebook B′={(w₁,w₂, . . . wₛ)|wᵢ=kᵢrσᵢ′, i=1,2, . . . s, kᵢεZ};

(ii) selecting a new random vector δ′=(δ₁′δ₂′ . . . δₛ′), where all components are random, such that

(iii) codeword vector c″ is a codeword in the codebook B′, where c″=μ′−δ′;

the codeword c″ is then mapped into an integer y. For example, the hash value of c″ can be calculated. If there is other information z (such as the keyed characters) which can be used to generate the key, h₁(y, z) is the biometric key K″ Otherwise, h₂(y) can be the biometric key K″. h₁(·) and h₂(·) are a one way hash function. This step is the same as the fourth of FIG. 1 described above;

the hash value of K″ is then calculated with a one-way hash function h(·); and, finally,

the codeword c″ and mean vector μ′ are discarded; and the random vector δ′ and variance vector σ′, as well as the hash of the key h(K″), are deposited into the database in place of those which previously existed. The biometric key is K″.

As can be determined from the above description the present invention is a method and system whereby a key can be obtained from individual's biometric information. It extracts a feature vector from the biometric data and transforms this vector into a codeword. The codeword is used to construct a key. If the user matches a commitment, the user is confirmed. To keep pace with gradual change in the biometric information, the invention can update it adaptively. If the user wants to have a fixed secret, they can encrypt their secret with the latest biometric key and store the ciphertext into the database.

This invention can be applied to many fields, such as access control, authentication, and secret key management. An application example is password hardening. Usually, a handheld computer stores much confidential information. Common password access control may not provide adequate security. If the user exploits biometric data such as, for example, the user entering their password, the password access control can be made more secure. If the keystroke duration and latency are the features, a keyboard analysis program can record the biometric. Using the present invention enables the user to generate a codeword and a secret key. The secret key can, with the password, jointly produce a biometric key. Another example is to encrypt a private key with a biometric key to manage the private key.

The present invention may be performed on a computer using a computer-readable medium containing program instructions for performing the method. The media may include any suitable form such as, for example, a floppy disk; CDROM, or by streaming or downloading over, for example, the Internet.

The program instructions include the steps of receiving and recording biometric data obtained of and from a user. A feature vector is then extracted from the biometric data, and subsequently a mean vector of the biometric data and a variance vector of the biometric data are also extracted. The next program instruction step is to generate a codeword from the mean vector and a random vector; and mapping the codeword into an integer by calculating the hash value of the codeword. The key is generated from the integer. The codeword is obtained from the difference between the mean vector and the random vector. The random vector is generated such that all components of the random vector are random. The codeword is in a codebook, the codebook being determined by the variance vector. The generation of the key is by generating the hash value of the integer.

A one-way hash of the key is stored in a database with the random vector and the variance vector. The one-way hash of the key may be compared to the one-way hash of a new key for verification of the new key. The new key is generated by extracting a new feature vector from the new biometric data, recovering the random vector, generating a new codeword from the new feature vector and the random vector, and generating the new key from the new codeword. The new codeword is first mapped into a new integer by calculating a one-way hash of the new codeword.

Following verification of the new key the variance vector and the random vector are recovered from the database, and a new variance vector calculated using the variance vector and the new biometric data to form a recalculated variance vector, and a new random vector is generated. The recalculated variance vector and the new random vector are then stored in the database in place of the variance vector and random vector respectively.

Whist there bas been described in the foregoing description in a preferred embodiment of the present invention, it will be understood by those skilled in the technology that many variations or modification may be made without departing from the present invention.

1. A method for generating a secret from biometric data obtained of and from a user, the method including the steps of:
(a) extracting a feature vector from the biometric data;
(b) extracting from the biometric data a mean vector of the biometric data and a variance vector after the feature vector is extracted; and
(c) generating a codeword from the mean vector and a random vector; and
(d) generating the secret from the codeword.

2. A method as claimed in claim 1, wherein the codeword is first mapped into an integer.

3. A method as claimed in claim 2 wherein the random vector is generated with all components of the random vector being random.

4. A method as claimed in claim 1, wherein the codeword may be in a codebook, the codebook being determined from the variance vector.

5. A method as claimed in claim 1, wherein the codeword is obtained from the difference between the mean vector and the random vector.

6. A method as claimed in claim 2, wherein the mapping of the codeword is by calculating the hash value of the codeword.

7. A method as claimed in claim 2, wherein the integer is used to generate the secret.

8. A method as claimed in claim 7, wherein the generation of the secret is by generating the hash value of the integer.

9. A method as claimed in claim 1, wherein a one-way hash of the secret is stored in a database.

10. A method as claimed in claim 9, wherein the random vector and the variance vector are also stored in the database.

11. A method as claimed in claim 1, wherein the biometric data is captured a plural number of times.

12. A method as claimed in claim 9, wherein the stored one-way hash of the secret is compared to a one-way hash of a new secret obtained from new biometric data captured of and from the user, the new biometric data being obtained for verification of the new secret.

13. A method as claimed in claim, 12, wherein the new secret is generated by extracting a new feature vector from the new biometric data, recovering the random vector, generating a new codeword from the new feature vector and the random vector, and generating the new secret from the new codeword.

14. A method as claimed in claim 13, wherein the new codeword is first mapped into a new integer by calculating a one-way hash of the new codeword.

15. A method as claimed in claim 13, wherein following verification of the new secret, the variance vector and the random vector are recovered from the database, the variance vector recalculated using the variance vector and the new biometric data to form a recalculated variance vector, and a new random vector is generated.

16. A method as claimed in claim 15, wherein the recalculated variance vector and new random vector are stored in stead of the variance vector and random vector respectively.

17. A method as claimed in claim 1, wherein the secret is an encryption key.

18. A computer-readable medium containing program instructions for generating a secret from biometric data obtained of and from a user, including the steps of:
(a) capturing the biometric data;
(b) extracting a feature vector from the biometric data;
(c) extracting from the biometric data a mean vector of the biometric data and a variance vector after the feature vector is extracted;
(d) generating a codeword from the mean vector and a random vector; and
(e) generating the secret from the codeword.

19. A computer-readable medium as claimed in claim 18, wherein the codeword is first mapped into an integer.

20. A computer-readable medium as claimed in claim 19, wherein the random vector is generated with all components of the random vector being random.

21. A computer-readable medium as claimed in claim 18, wherein the codeword is in a codebook, the codebook being determined from the variance vector.

22. A computer-readable medium as claimed in claim 19, wherein the codeword is obtained from the difference between the mean vector and the random vector.

23. A computer-readable medium as claimed in claim 19, wherein the mapping of the codeword is by calculating the hash value of the codeword.

24. A computer-readable medium as claimed in claim 19, wherein the integer is used to generate the secret.

25. A computer-readable medium as claimed in claim 24, wherein the generation of the secret is by generating the hash value of the integer.

26. A computer-readable medium as claimed in claim 18, wherein a one-way hash of the secret is stored in a database.

27. A computer-readable medium as claimed in claim 26, wherein the random vector and the variance vector are also stored in the database.

28. A computer-readable medium as claimed in claim 18, wherein the biometric data is captured a plural number of times.

29. A computer-readable medium as claimed in claim 26, wherein the stored one-way hash of the secret is compared to a one-way hash of a new secret obtained from new biometric data captured of and from the user, the new biometric data being obtained for verification of the new secret.

30. A computer-readable medium as claimed in claim 29, wherein the new secret is generated by extracting a new feature vector from the new biometric data, recovering the random vector, generating a new codeword from the new feature vector and the random vector, and generating the new secret from the new codeword.

31. A computer-readable medium as claimed in claim 30, wherein the new codeword is first mapped into a new integer by calculating a one-way hash of the new codeword.

32. A computer-readable medium as claimed in claim 29, wherein following verification of the new secret, the variance vector and the random vector are recovered from the database, the variance vector recalculated using the variance vector and the new biometric data to form a recalculated variance vector, and a new random vector is generated.

33. A computer-readable medium as claimed in claim 30, wherein the recalculated variance vector and new random vector are stored in the database in stead of the variance vector and random vector respectively.

34. A computer-readable medium as claimed in claim 18, wherein the secret is an encryption key.
